(19) United States
(12) Patent Application Publication
(10) Pub. No.: US 2011/0029156 A1
(43) Pub. Date: Feb. 3, 2011

(54) WIRELESS SENSOR SYSTEM FOR A MOTOR VEHICLE

(75) Inventors: Mark A. Vernacchia, Northville, MI (US); Jack P. Koski, South Lyon, MI (US); Michael Joseph Balsamo, San Francisco, CA (US)

Correspondence Address: VIVACQUA LAW, PLLC, 455 East Eisenhower Parkway, Suite 200, ANN ARBOR, MI, 48108, US

(73) Assignee: GM GLOBAL TECHNOLOGY OPERATIONS, INC., Detroit, MI (US)

(21) Appl. No.: 12/828,636

(22) Filed: Jul. 1, 2010

Related U.S. Application Data
(60) Provisional application No. 61/230,386, filed on Jul. 31, 2009.

(51) Int. Cl. G06F 19/00; H04B 7/00

(52) U.S. Cl. 701/2; 455/41.2

(57) ABSTRACT

A wireless sensor system for a transmission and other powertrain components in a motor vehicle includes a wireless sensor connected to a component of the motor vehicle. The wireless sensor includes an antenna in communication with a wireless power source and with a wireless transceiver. The wireless power source includes an emitter that creates an electromagnetic resonance between the emitter and the sensor. The wireless transceiver is in communication with the sensor and sends and receives signals to and from the wireless sensor.

### CROSS-REFERENCE TO RELATED APPLICATIONS

This application claims priority to U.S. Provisional Application No. 61/230,386, filed on Jul. 31, 2009, which is hereby incorporated in its entirety herein by reference.

### FIELD

The present disclosure relates to wireless sensors, and more particularly to a wireless sensor system having wireless power and wireless communication used in control systems for various powertrain components in a motor vehicle.

### BACKGROUND

The statements in this section merely provide background information related to the present disclosure and may or may not constitute prior art.

Transmissions and other powertrain components in automotive vehicles are complex mechanisms controlled by hydraulic systems and electronic control modules. In order to provide proper control, it is necessary to have feedback on the operating conditions and performance of the transmission as the transmission operates. For example, transmissions typically include a plurality of sensors that communicate information indicative of the operating state of the transmission to the electronic controller. These sensors take many forms and perform various functions. For example, it is often desirable to determine the torque on a rotating shaft (rotator) relative to a stationary component (stator). Accordingly, a torque sensor is used to measure the torque. Common torque sensors include strain gages, magnetic or optical sensors, and surface acoustic wave (SAW) sensors. These torque sensors each measure various parameters such as local strain, angular displacement, or strained-induced change on an acoustic wave. Typically these torque sensors have two components including what can generally be referred to as a transmitter and a receiver. The receiver is typically coupled to the rotator and the transmitter is coupled to the stator. In the case of magnetic sensors and SAW sensors, a current is induced through the transmitter and torque applied on the rotator is transmitted back to the transmitter in a form of current, radio signal or magnetic field which is then converted into an estimated torque.

Another common sensor used in transmissions includes temperature sensors. A transmission temperature sensor may be located in a sump or connected to an in-line stator. Typically, the temperature sensor has an electrical resistance that is a function of the temperature of the transmission oil. An electrical signal indicative of the resistance, which is inversely proportional to the temperature, is communicated to the controller of the transmission. Other sensor systems used in transmissions include, but are not limited to, pressure sensors, flow meter sensors, and linear position sensors in synchronizer assemblies.

One limitation with the above described transmission sensors is that the sensor must be connected to a power source and the information sensed by the sensor must be communicated to the transmission controller. Power to the sensor is provided via wires that are connected from a power source to the sensor or by providing a battery with the sensor. The wires used to power the sensor, however, limit the locations that the sensor can be placed. For example, due to the need to physically route the wires through the components of the transmission and to physically connect with the sensor, is it not possible to locate the sensor directly on a rotating component or in a sealed area of the transmission. Therefore, each sensor must be calibrated to account for the physical characteristics of the transmission, such as for hydraulic clutch oil routings, in order to increase the accuracy of the sensor readings. In addition, the wire routing increases the cost and complexity of the transmission. Finally, while batteries eliminate the need for wires and the issues associated with wire routing, the batteries have a limited life expectancy and cannot be easily replaced.

While current transmission sensors are useful for their intended purpose, there is room in the art for an improved sensor system for a powertrain component that has wireless communication and wireless power in order to reduce the cost and complexity of wires and wire harness routing, to allow sensors to be located directly on torque and position control devices, and to provide accurate real time information from the sensor to enable closed loop pressure control of a transmission in order to provide real time feedback during shift events.

### SUMMARY

A wireless sensor system for a transmission and other powertrain components in a motor vehicle is provided. The wireless sensor system includes a wireless sensor connected to a component of the transmission and other powertrain components in a motor vehicle. The wireless sensor includes an antenna in communication with a wireless power source and with a wireless transceiver. The wireless power source includes an emitter that creates an electromagnetic resonance between the emitter and the sensor. The wireless transceiver is in wireless communication with the sensor and sends and receives signals to and from the wireless sensor.

In one example of the present invention, the wireless sensor is one of a torque sensor, a temperature sensor, a pressure sensor, a linear displacement sensor, and a flow meter sensor.

In another example of the present invention, the wireless sensor is connected to a rotating clutch.

In yet another example of the present invention, the wireless sensor is located within a sealed area of a transmission.

In yet another example of the present invention, the wireless sensor is located in a transfer case.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic diagram of an exemplary transmission having a wireless sensor system according to the principles of the present invention; and

FIG. 2 is a schematic diagram of an exemplary transmission having another example of a wireless sensor system according to the principles of the present invention.

### DETAILED DESCRIPTION

The following description is merely exemplary in nature and is not intended to limit the present disclosure, application, or uses.

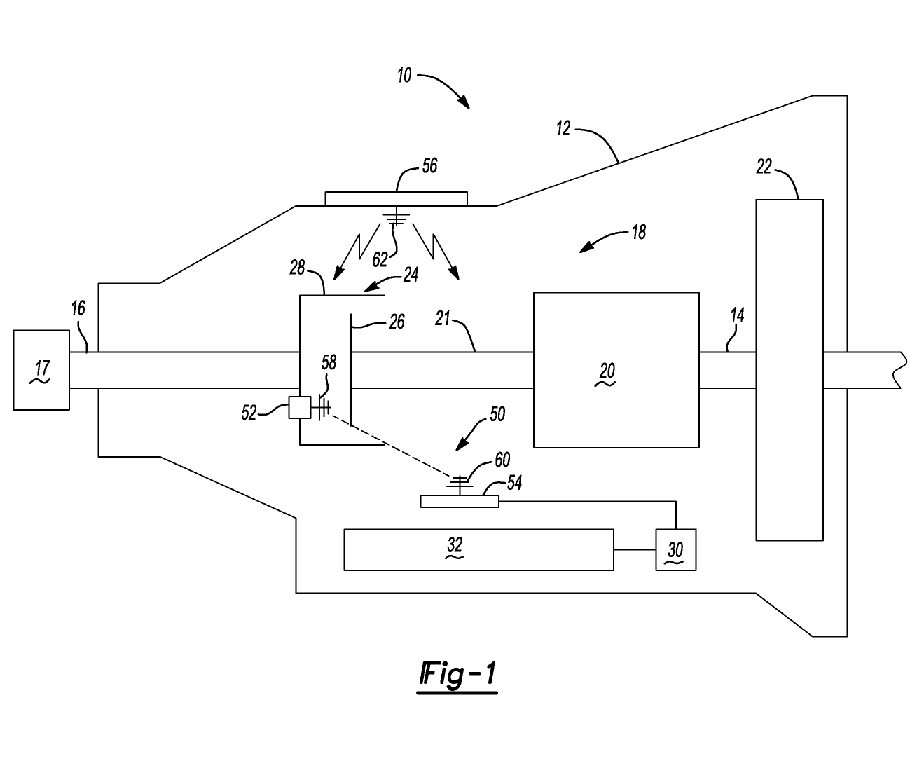

With reference to FIG. 1, a schematic diagram of an exemplary transmission for a motor vehicle is generally indicated by reference number 10. While in the example provide the transmission 10 is an automatic multiple speed transmission, it should be appreciated that the transmission may be a manual transmission, a dual clutch transmission, a continuously variable transmission, a hybrid transmission, a straight single-drive gearbox, and a rear wheel or front wheel, or all wheel drive transmission, etc., without departing from the scope of the present invention. The transmission 10 includes a typically cast, metal housing 12 which encloses and protects the various components of the transmission 10. The housing 12 includes a variety of apertures, passageways, shoulders and flanges which position and support these components. The transmission 10 includes an input shaft 14, an output shaft 16, and an exemplary gear arrangement 18. The input shaft 14 is connected with a prime mover (not shown) via a torque converter 22. The prime mover may be an internal combustion gas or Diesel engine or a hybrid power plant. The input shaft 14 receives input torque or power from the prime mover. In the example provided, the output shaft 16 is connected with a transfer case 17 (either all wheel drive or four wheel drive). However, the output shaft 16 may be connected directly with a final drive unit (not shown) which may include, for example, propshafts, differential assemblies, and drive axles. The input shaft 14 is coupled to and drives the gear arrangement 18.

The gear arrangement 18 may take various forms and configurations but generally includes at least one gear set 20, at least one shaft 21, and at least one torque transmitting mechanism 24. The gear set 20 may include intermeshing gear pairs, a planetary gear set, or any other type of gear set. The gear set 20 is connected to and receives input torque from the input shaft 14. The shaft 21 may be a layshaft, a countershaft, sleeve or center shaft, a reverse or idle shaft, or combinations thereof. The shaft 21 connects the gear set 20 with the torque transmitting mechanism 24. The torque transmitting mechanism 24 is illustrated in the example provided as a rotating clutch having a rotating hub 26 connected with the shaft 21 and a rotating housing 28 connected with the output shaft 16. However, the torque transmitting mechanism 24 may be, for example, a synchronizer assembly or dog clutch, a wet or dry clutch, and brake without departing from the scope of the present invention. The rotating hub 26 is selectively engageable to engage the rotating housing 28 in order to transmit torque between the rotating hub 26 and the rotating housing 28.

The transmission 10 also includes a transmission control module 30. The transmission control module 30 is preferably an electronic control device having a preprogrammed digital computer or processor, control logic, memory used to store data, and at least one I/O peripheral. The control logic includes a plurality of logic routines for monitoring, manipulating, and generating data. The transmission control module 30 controls the actuation of the torque transmitting device 24 via a hydraulic control system 32. The hydraulic control system 32 generally includes electrically controlled solenoids and valves that selectively communicate a hydraulic fluid throughout the transmission 10 in order to control, lubricate, and cool the various components of the transmission 10.

The transmission 10 further includes a wireless sensor system 50 according to the principles of the present invention. The wireless sensor system 50 generally includes at least one wireless sensor 52, a wireless transceiver 54, and a wireless power source 56. The wireless sensor 52, in the example provided, is connected to the housing 28 of the torque transmitting device 24. However, it should be appreciated that the wireless sensor 52 may be located in other positions and on other components within the transmission 10, rotating or stationary, without departing from the scope of the present invention. For example, the wireless sensor 52 may be located in the transfer case 17, or in various other locations not limited to the transmission, such as attached to a component or feature within the powertrain of the motor vehicle.

The wireless sensor 52 may take various forms such as, for example, a surface acoustic wave (SAW) sensor, a bulk acoustic wave (BAW) sensor, a surface acoustic wave filter, a surface acoustic wave resonator, a surface acoustic wave delay line, a bulk acoustic wave resonator or a magneto-elastic toque sensor that measures a magnetic flux, a strain gage, a magnetic or optical sensor, a temperature sensor, a pressure sensor, a flow meter sensor, and a linear displacement sensor. The wireless sensor 52 includes an antenna 58. The antenna 58 is a radio frequency (RF) receiver for communicating with the transceiver and electromagnetic (EM) radiation receiver for receiving power transmitted from the wireless power source 56.

The wireless transceiver 54 includes a transmitter and a receiver which are combined and share common circuitry or a single housing. The transceiver 54 is preferably an RF transceiver but may be any other kind of transceiver, such as a wireless (WAP) transceiver, without departing from the scope of the present invention. The transceiver 54 includes an antenna 60. The antenna 60 is in wireless communication with the sensor 52. The transceiver 54 also is in electronic communication with the transmission controller 30, either via wires or via the antenna 60.

The wireless power source 56 is operable to generate EM power and includes an emitter 62. The emitter 62 is operable to emit oscillatory electromagnetic radiation that is received by the antenna 58 of the sensor 52. The oscillatory electromagnetic radiation received by the sensor 52 induces a current in the sensor 52, thereby powering the sensor 52. In another embodiment of the present invention, the wireless power source 56 charges a battery or capacitor located within or connected to the sensor 52. In the example provided, the wireless power source 56 is located outside the housing 12 of the transmission 10. However, the wireless power source 56 may be located within the housing 12 without departing from the scope of the present invention. The position of the wireless power source 56 is preferably influenced by the desired power transfer efficiency between the emitter 62 and the sensor 52 as well as packaging considerations. The power transfer efficiency is a function of absorption of the EM radiation by the environment, orientation and size of the emitter 62 and antenna 58 of the sensor 52, and the distance between the emitter 62 and the antenna 58. In the example provided, the wireless power source 56 operates continuously while the transmission 10 is in a drive mode or accessory mode of operation. Alternatively, the wireless power source 56 may operate periodically.

During operation of the wireless sensor system 50, the sensor 52 is powered by the wireless power source 56. The sensor 52 communicates signals wirelessly to the transceiver 54. These signals are indicative are indicative of certain transmission properties, such as torque, temperature, pressure, displacement, flow, or any other relevant property. These signals are then communicated to the transmission controller 30. The transmission controller 30 uses these signals to control the operation of the transmission 10 via the hydraulic control system 32. In the case of a torque sensor located directly on the rotating housing 28 of the torque transmitting device 24, the information received by the sensor 52 allows the transmission controller 30 to adjust the closed loop pressure to the torque transmitting device 24 via the hydraulic control system 32 in real time during a shift event.

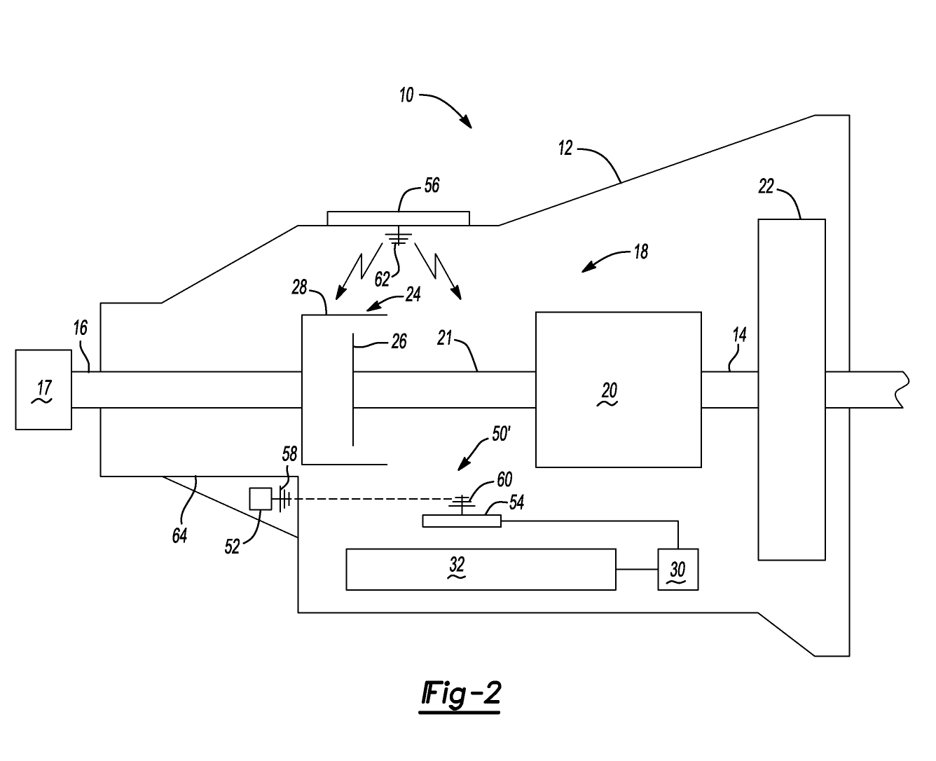

Turning to FIG. 2, another embodiment of a wireless sensor system is indicated by reference number 50′. In the wireless sensor system 50′, the sensor 52 is located within a sealed section 64 of the transmission 10. The sealed section 64 may be connected to the housing 12 or a separate area of the transmission 10. By providing the sensor 52 with wireless power and wireless communication, the sensor 52 can be located within the sealed section 64 without requiring additional seals to maintain the sealing integrity of the sealed section 64.

The description of the invention is merely exemplary in nature and variations that do not depart from the gist of the invention are intended to be within the scope of the invention. Such variations are not to be regarded as a departure from the spirit and scope of the invention.

The following is claimed:

1. A wireless sensor system for a transmission and other powertrain components in a motor vehicle, the transmission and other powertrain components in a motor vehicle having a housing and a component disposed within the housing, the wireless sensor system comprising:
a receiver disposed within the housing;
a power source coupled to the housing, the power source having an emitter configured to emit oscillatory electromagnetic radiation; and
a wireless sensor having an electromagnetic radiation receiver and an antenna and coupled to the component within the housing, wherein the oscillatory electromagnetic radiation receiver receives the emitted oscillatory electromagnetic radiation and induces a current in the sensor thereby powering the sensor, and wherein the antenna transmits a signal to the receiver indicative of a condition sensed by the wireless sensor.

2. The wireless sensor system of claim 1 wherein the antenna of the wireless sensor is a radio frequency antenna.

3. The wireless sensor system of claim 1 wherein the wireless sensor is at least one of a surface acoustic wave (SAW) sensor, a bulk acoustic wave (BAW) sensor, a surface acoustic wave filter, a surface acoustic wave resonator, a surface acoustic wave delay line, a bulk acoustic wave resonator or a magneto-elastic toque sensor that measures a magnetic flux, a strain gage, a magnetic or optical sensor, a temperature sensor, a pressure sensor, a flow meter sensor, and a linear displacement sensor.

4. The wireless sensor system of claim 1 wherein the wireless sensor is rotated.

5. The wireless sensor system of claim 1 wherein the receiver is a transceiver that includes a transmitter and a receiver which are combined and share common circuitry and a single housing.

6. The wireless sensor system of claim 5 wherein the transceiver includes a radio frequency antenna.

7. The wireless sensor system of claim 6 wherein the transceiver uses wireless application protocol to communicate with the sensor.

8. The wireless sensor system of claim 1 wherein the power source transmits the oscillatory electromagnetic radiation continuously while the transmission is in a drive mode or an accessory mode of operation.

9. The wireless sensor system of claim 1 wherein the sensor includes a power storage device, and wherein the power source transmits the oscillatory electromagnetic radiation periodically to charge the power storage device.

10. The wireless sensor system of claim 9 wherein the power storage device is one of a battery or a capacitor.

11. The wireless sensor system of claim 1 wherein the sensor is located in a transfer case.

12. A transmission comprising:
a housing;
a component disposed within the housing;
a transceiver disposed within the housing;
a power source coupled to the housing, the power source having an emitter configured to emit oscillatory electromagnetic radiation; and
a wireless sensor coupled to the component, the wireless sensor having an antenna for wirelessly communicating with the transceiver and for receiving the oscillatory electromagnetic radiation from the power source, wherein the oscillatory electromagnetic radiation received by the sensor induces a current in the sensor thereby powering the sensor and the antenna transmits a signal to the transceiver indicative of a condition sensed by the wireless sensor.

13. The transmission of claim 12 wherein the antenna of the wireless sensor is a radio frequency antenna.

14. The transmission of claim 12 wherein the wireless sensor is at least one of a surface acoustic wave (SAW) sensor, a bulk acoustic wave (BAW) sensor, a surface acoustic wave filter, a surface acoustic wave resonator, a surface acoustic wave delay line, a bulk acoustic wave resonator or a magneto-elastic toque sensor that measures a magnetic flux, a strain gage, a magnetic or optical sensor, a temperature sensor, a pressure sensor, a flow meter sensor, and a linear displacement sensor.

15. The transmission of claim 12 wherein the transceiver includes a radio frequency antenna.

16. The transmission of claim 12 wherein the transceiver uses wireless application protocol to communicate with the sensor.

17. The transmission of claim 12 wherein the power source transmits the oscillatory electromagnetic radiation continuously while the transmission is in a drive mode or an accessory mode of operation.

18. The transmission of claim 12 wherein the sensor includes a power storage device, and wherein the power source transmits the oscillatory electromagnetic radiation periodically to charge the power storage device.

19. The transmission of claim 12 wherein the component is rotated.

20. The transmission of claim 12 further comprising a controller, wherein the transceiver is in electronic communication with the controller.

21. The transmission of claim 12 wherein the transceiver receives the emitted oscillatory electromagnetic radiation which powers the transceiver.

22. The transmission of claim 12 wherein the component is located in an area of the transmission sealed from the transceiver.

23. A transmission comprising:
a housing;
a rotating clutch disposed within the housing;
a hydraulic control system configured to engage and disengage the rotating clutch;
a controller configured to control the hydraulic control system;
a transceiver disposed within the housing and in electronic communication with the controller;
a power source coupled to the housing, the power source having an emitter configured to emit oscillatory electromagnetic radiation; and
a wireless sensor coupled to the rotating clutch, the wireless sensor having an antenna for wirelessly communicating with the transceiver and an electromagnetic radiation receiver for receiving the oscillatory electromagnetic radiation from the power source, wherein the oscillatory electromagnetic radiation received by the sensor induces a current in the sensor thereby powering the sensor, and wherein the wireless sensor senses data and the data is wirelessly communicated to the transceiver, and
wherein the data received by the transceiver and communicated to the controller allows the controller to adjust a closed loop pressure to the torque transmitting device via the hydraulic control system in real time during a shift event.
